(19) United States
(12) Patent Application Publication
(10) Pub. No.: US 2014/0048375 A1
(43) Pub. Date: Feb. 20, 2014

(54) POWER TRANSMITTING APPARATUS

(71) Applicant: Kabushiki Kaisha F.C.C., Hamamatsu-shi (JP)

(72) Inventors: Shouji Asatsuke, Hamamatsu-shi (JP); Takumi Nagata, Hamamatsu-shi (JP); Jun Ishimura, Hamamatsu-shi (JP)

(73) Assignee: Kabushiki Kaisha F.C.C., Hamamatsu-shi (JP)

(21) Appl. No.: 14/063,831

(22) Filed: Oct. 25, 2013

Related U.S. Application Data
(63) Continuation of application No. PCT/JP2012/061341, filed on Apr. 27, 2012.

(30) Foreign Application Priority Data
Apr. 28, 2011 (JP) 2011-102058

(51) Int. Cl. F16D 21/06

(52) U.S. Cl. CPC F16D 21/06
USPC 192/48.609

(57) ABSTRACT

A power transmitting apparatus configured to connect an input from an engine and an output to a driving wheel side at a predetermined gear ratio and to arbitrarily set the gear ratio during power transmission from the engine to the wheels. The apparatus comprises: a first partition member and a second partition member arranged opposite each other to form hydraulic chambers; a first clutch disc group comprising interleaved driving and driven clutch discs; a second clutch disc group comprising interleaved driving and driven clutch discs; and a hydraulic piston actuated by hydraulic pressure supplied to the hydraulic chambers to engage or disengage the driving and driven clutch discs of either of the first clutch disc group or the second clutch disc group depending on the actuated direction of the hydraulic piston, the driving power transmitted at a desirable gear ratio by selectively actuating the hydraulic piston.

### INCORPORATION BY REFERENCE TO ANY PRIORITY APPLICATIONS

Any and all applications for which a foreign or domestic priority claims is identified in the Application Data Sheet as filed with the present application are hereby incorporated by reference under 37 C.F.R. 1.57.

### BACKGROUND

1. Technical Field

The present disclosure relates to a power transmitting apparatus arranged on a power transmitting path between an engine and driving wheels and adapted to connect an input from an input shaft of the engine side and an output to the driving wheel side at a predetermined gear ratio and to arbitrarily set the gear ratio during power transmission from the engine to the wheels in accordance with running conditions of a vehicle.

2. Description of the Related Art

Regarding power transmitting apparatuses for selectively transmit or cut off the driving power of an engine to wheels of vehicle, there are two types of transmissions: a manual transmission (MT), with its speed shifting operation being manually carried out; and an automatic transmission (AT) with its speed shifting operation being automatically carried with the use of a torque converter. Although the AT can easily achieve the speed shifting operation it is inferior in power transmitting efficiency. Accordingly, it has been proposed an AMT type power transmitting apparatus which can automatically perform the speed shifting operation without using the torque converter.

Such an AMT type power transmitting apparatus comprises a start/speed shifting clutch for transmitting or cutting off the power transmitting path between an engine and wheels, and a plurality of gear-stage clutch means for which input and output are set at a predetermined gear ratio. The gear-stage clutch means comprises a synchronizing mechanism and a dog clutch and is formed so that the gear ratio during power transmission from an engine to wheels can be arbitrarily set by selectively connecting the dog clutch to any one of gear-stage clutch means.

However, there is a problem that the speed shifting time lag would become large in the power transmitting apparatus of the prior art since the gear ratio is set by selecting an arbitrary gear-stage with use of a synchronizing mechanism and a dog clutch forming the gear-stage clutch means. Accordingly the applicant of the present application has devised a power transmitting apparatus comprising driving clutch discs and driven clutch discs alternately interleaved with each other, and a hydraulic piston for selectively actuating the driving clutch discs and driven clutch discs to engage and disengage them so that a driving power can be transmitted at a predetermined gear ratio when the driving clutch discs and driven clutch discs are engaged.

For example, a power transmitting apparatus shown in FIG. 6 has been proposed which comprises a clutch means 104 formed from clutch disc groups 106, 107 arranged beside each other for transmitting the driving power at different gear ratios (e.g., based on gears Ga, Gb of different diameters) and a hydraulic piston 105 arranged between the clutch disc groups 106, 107. The engagement of driving clutch discs and driven clutch discs of the clutch disc group 106 can be achieved by supplying an oil passage 101a formed within an input shaft 100 with hydraulic oil and leading the hydraulic oil to a hydraulic chamber S2 via a hydraulic oil supplying port 102 to move a hydraulic piston 105 toward the left in FIG. 6. On the contrary, the engagement of driving clutch discs and driven clutch discs of the clutch disc group 107 can be achieved by supplying an oil passage 101b formed within the input shaft 100 with hydraulic oil and leading the hydraulic oil to a hydraulic chamber Si via a hydraulic oil supplying port 103 to move a hydraulic piston 105 toward the right in FIG. 6.

The input shaft 100 is formed with a spline 100a on its outer circumference at a predetermined position thereon and engaged with an interlocking member 108 via a spline 108b formed thereon. In addition, another interlocking member 109 is engaged with the interlocking member 108 via a spline-engagement of a spline 109b formed on the interlocking member 109 and the spline 108b of the interlocking member 108.

The interlocking members 108, 109 are formed respectively with partition portions 108a, 109a extending radially outward from them to form hydraulic chambers S1, S2. That is, the hydraulic chambers S1, S2 are defined by the oppositely arranged partition portions 108a, 109a and a hydraulic piston 105 arranged between them.

### SUMMARY

In the power transmitting apparatus of FIG. 6 described above, since there are spline-engagements not only between the input shaft 100 and the interlocking member 108, but also between the interlocking member 108 and the interlocking member 109, the size of the power transmitting apparatus would be increased. That is, the presence of the spline-engagements between the input shaft 100 and the interlocking member 108 and between the interlocking member 108 and the interlocking member 109 would increase the size in a radial direction (e.g., increase the width) of the power transmitting apparatus. In addition, since the region in which the splines are formed is extensive in an axial direction, the axial size (e.g., the height) of the power transmitting apparatus would also be increased. Furthermore, it a further problem that, since the driving power of the input shaft 100 is transmitted to the interlocking member 109 via the interlocking member 108, efficient power transmission could not be achieved.

It is therefore an object of the present disclosure to provide a power transmitting apparatus which can reduce the size of the power transmitting apparatus and improve the power transmitting efficiency.

For achieving the object mentioned above, there is provided, according to some embodiments, a power transmitting apparatus arranged on a power transmitting path between an engine and driving wheels and adapted to connect an input from an input shaft of an engine side of the power transmitting apparatus and an output to a driving wheel side of the power transmitting apparatus at a predetermined gear ratio and arranged to arbitrarily set the gear ratio during power transmission from the engine to the driving wheels, the power transmitting apparatus comprising a first partition member and a second partition member spline-engaged with the input shaft, the first partition member and second partition member configured to be rotated together with the input shaft and arranged oppositely to each other to form hydraulic chambers; a first clutch disc group comprising driving clutch discs spline-engaged with the first partition member and driven clutch discs spline-engaged with the output member, the driving clutch discs and the driven clutch discs of the first clutch disc group being alternately interleaved with each other; a second clutch disc group comprising driving clutch discs spline-engaged with onto the second partition member and driven clutch discs spline-engaged with the output member, the driving clutch discs and the driven clutch discs of the second clutch disc group being alternately interleaved with each other; and a hydraulic piston configured to be actuated by hydraulic pressure supplied to the hydraulic chambers to selectively engage or disengage the driving clutch discs and driven clutch discs of either one of the first clutch disc group or the second clutch disc group in accordance with an actuated direction of the hydraulic piston, a driving power configured to be transmitted at a desirable gear ratio by selectively actuating the hydraulic piston.

In some embodiments, the hydraulic piston comprises a hydraulic pressure receiving portion positioned within the hydraulic chambers for receiving the hydraulic pressure, an actuating portion integrally formed with the hydraulic pressure receiving portion for engaging and disengaging the driving clutch discs and the driven clutch discs of the first clutch disc group and the second clutch disc group, and sealing means for sealing the hydraulic chambers.

In some cases, the input shaft is formed with hydraulic oil supplying ports for supplying the hydraulic chambers with hydraulic oil, the input shaft further formed with a splined portion able to be engaged with the first and second partition members and a non-splined portion in which openings of the hydraulic oil supplying ports are formed, and wherein the splined portion and the non-splined portion are formed on a same plane of a radial cross-section of the input shaft.

In some embodiments, annular sealing members are mounted on an outer circumference of the input shaft so that they encircle the openings of the hydraulic oil supplying ports.

In some instances, since the first partition member and the second partition member can be spline-engaged with the input shaft so as to be rotated together therewith and arranged oppositely to each other to form the hydraulic chambers, it is possible to reduce the size of the power transmitting apparatus and to improve its power transmitting efficiency.

In some embodiments, since the hydraulic piston can comprise a hydraulic pressure receiving portion positioned within the hydraulic chambers for receiving the hydraulic pressure, an actuating portion integrally formed with the hydraulic pressure receiving portion for engaging and disengaging the driving clutch discs and the driven clutch discs of the first clutch disc group and the second clutch disc group, and sealing means for sealing the hydraulic chambers, it is possible to surely transmit the hydraulic pressure received by the hydraulic pressure receiving portion to the actuating portion and to more surely engage or disengage the driving clutch discs and driven clutch discs of either one of the first clutch disc group or the second clutch disc group.

In some cases, since the input shaft is formed with hydraulic oil supplying ports for supplying the hydraulic chambers with hydraulic oil, and further formed with a splined portion able to be engaged with the first and second partition members and a non-splined portion in which the openings of the hydraulic oil supplying ports are formed, and the splined portion and the non-splined portion are formed on the same plane of a radial cross-section of the input shaft, it is possible to further reduce the axial size (e.g., the height) and thus the whole size of the power transmitting apparatus.

In some embodiments, since annular sealing members are mounted on the outer circumference of the input shaft so that they encircle the openings of the hydraulic oil supplying ports, it is possible to independently seal respective the hydraulic oil supplying ports.

### BRIEF DESCRIPTION OF THE DRAWINGS

FIG. 1 is a diagrammatic view showing a whole structure of a vehicle to which the power transmitting apparatus of the present disclosure is applied;

FIG. 2 is a longitudinal sectional view showing the power transmitting apparatus of the present disclosure;

FIG. 3 is an exploded longitudinal sectional view showing a first partition member, a second partition member, a hydraulic piston, etc.;

FIG. 4 is a partially enlarged view showing a region near hydraulic oil supplying ports of the input shaft of the power transmitting apparatus of the present disclosure;

FIG. 5 is a cross-sectional view taken along a line V-V in FIG. 4; and

FIG. 6 is a longitudinal sectional view showing a power transmitting apparatus of the prior art.

### DETAILED DESCRIPTION

Preferable embodiments of the present disclosure will be described with reference to accompanied drawings.

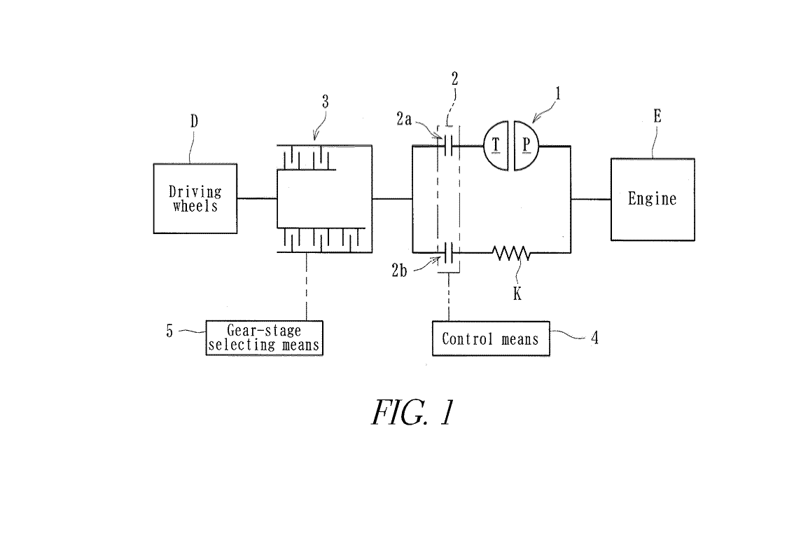

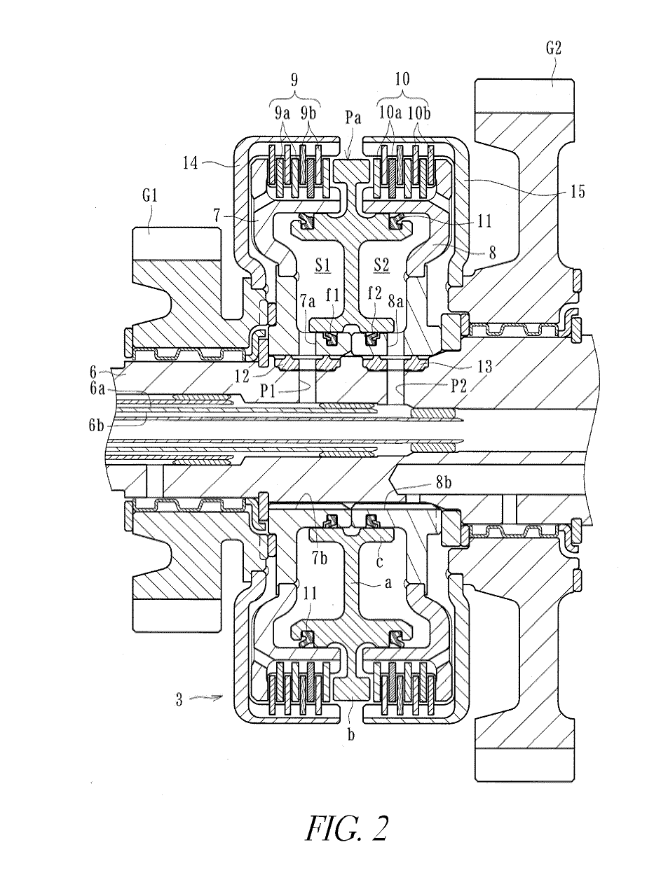

The power transmitting apparatus of the present disclosure is intended to transmit or cut off the driving power of an engine (e.g., the driving source) E of an automobile (e.g., a vehicle) to or from the wheels (e.g., the driving wheels) D. The power transmitting apparatus mainly comprises, as shown in FIGS. 1 and 2, a torque converter 1, a start/speed shifting clutch 2, a gear-stage clutch 3, a controller 4, and a gear-stage selector 5. As shown in FIG. 1, the torque converter 1, the start/speed shifting clutch 2 and the gear-stage clutch 3 are arranged on the way of a power transmitting path from the engine E to wheels (e.g., driving wheels) D.

The torque converter 1 has a torque amplifying function for amplifying the torque from the engine E and transmitting it to the driving wheels D. The torque converter 1 mainly comprises a torque converter cover (not shown) rotated around its shaft by the driving force transmitted from the engine E and tightly containing liquid (e.g., operating oil), a pump P formed on the side of the torque converter cover, and a turbine T arranged oppositely to the pump P and rotatable at the side of the torque converter cover.

When the torque converter cover and the pump P are rotated by the driving force of the engine E, the rotational torque is transmitted to the turbine T via the liquid (e.g., operating oil) with the torque being amplified. When the turbine T is then rotated by the amplified torque, the first driving shaft spline-engaged with the turbine T is rotated and thus amplified torque is transmitted to the driving wheels D via the gear-stage clutch 3. In some embodiments, the gear-stage clutch 3 can serve as a means for transmitting or cutting off the amplified torque from the turbine T to the driving wheels D. Thus the power transmitting apparatus of the present disclosure has a driving power transmitting path (e.g., a power transmitting path of torque converter) comprising the torque converter cover, the pump P and the turbine T.

On the other hand, the torque converter cover is connected to a predetermined connecting member (not shown) via the damper mechanism K comprising coil springs and the connecting member is further fitted with a predetermined driving shaft (e.g., a second driving shaft) via an input shaft 6. Accordingly, the torque converter cover, the connecting member, and the second driving shaft are rotated by the driving power of the engine E, and thus the driving torque of the engine E is transmitted to the gear-stage clutch 3. That is, the second driving shaft enables to transmit the driving power of the engine E to the driving wheels D without transmitting power through the power transmitting path of the torque converter 1.

As described above, the first driving shaft can be rotated by the driving power of the engine E via the power transmitting path of the torque converter 1 and connected to the first clutch 2a of the start/speed shifting clutch 2, and the second driving shaft can be directly rotated by the driving power of the engine E without transmitting power through the power transmitting path of the torque converter 1 and can be connected to the second clutch 2b of the start/speed shifting clutch 2.

The start/speed shifting clutch 2 is intended to transmit or cut off the driving power of the engine E to or from the driving wheels D at an arbitrary timing and comprises the first clutch 2a for transmitting the driving power of the engine E to the driving wheels D via the power transmitting path of the torque converter 1 and a second clutch 2b for transmitting the driving power of the engine E to the driving wheels D without transmitting power through the power transmitting path of the torque converter 1. The start/speed shifting clutch 2 can serve as a means for transmitting or cutting off the driving power of the engine E to or from the driving wheels D. The first and second clutches 2a, 2b can be formed by multiple disc clutches.

The controller 4 can control the hydraulic oil pressure supplied to each gear-stage clutch 3 and is configured to selectively operate the first and second clutches 2a, 2b in accordance with conditions of vehicle. The controller 4 can serve as a means of controlling the hydraulic oil pressure supplied to each gear-stage clutch 3 and as a means of operating the first and second clutches 2a, 2b. Similarly to the gear-stage selector 5 described below, the controller 4 may be formed, for example, by a microcomputer loaded on a vehicle. The gear-stage clutch 3 is arranged between the start/speed shifting clutch 2 and the driving wheels D on the power transmitting path and its input (e.g., the rotational speed of the start/speed shifting clutch) and output (e.g., the rotational speed of the driving wheels) are set at predetermined ratios.

More particularly, the gear-stage clutch 3 of the present disclosure is mounted to the input shaft 6 as shown in FIG. 2. The gear-stage clutch 3 mainly comprises a first partition member 7, a second partition member 8, a first clutch disc group 9, a second clutch disc group 10, and a hydraulic piston Pa. Gears G1, G2 have different diameters and are able to transmit the driving power to an output shaft (e.g., a shaft formed with gears mating with the gears G1, G2 and connected to the driving wheels D; not shown). A plurality of the gear-stage clutches (not shown) other than the gear-stage clutch 3 which are able to transmit driving power to the gears G1, G2 at desirable gear ratios are arranged in the power transmitting apparatus of the present disclosure.

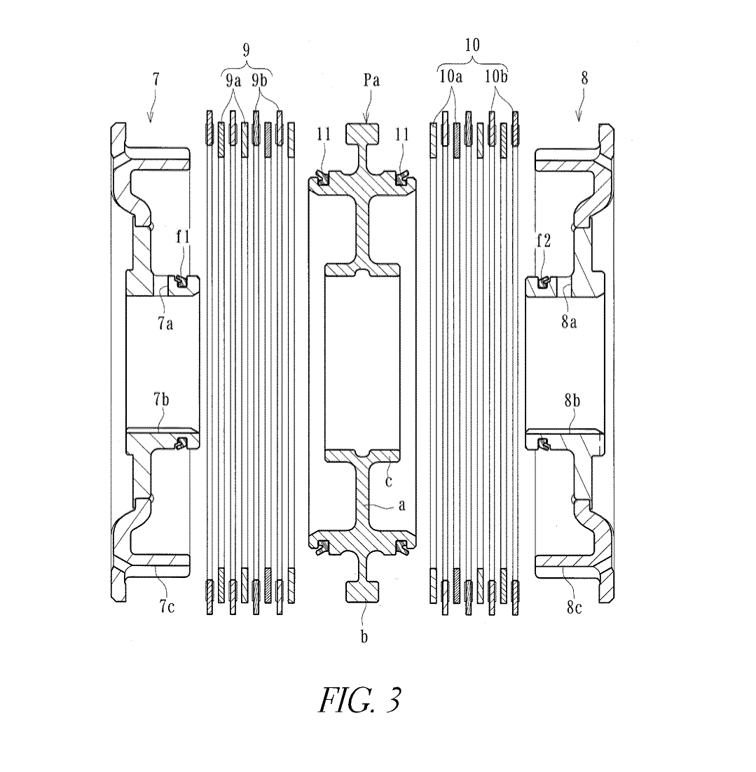

The first partition member 7 is spline-engaged with the input shaft 6 so as to be rotated together with the input shaft 6 and forms a hydraulic chamber S1 cooperating with the hydraulic piston Pa. In particular, the first partition member 7 is formed with a through aperture on which a spline 7b is formed so as to be engaged with the spline formed on the input shaft 6, as shown in FIG. 3. A reference numeral 7a denotes a hydraulic oil supplying aperture via which the operating oil can be supplied to the hydraulic chamber S1. In addition, a reference numeral 7c denotes a spline on which driving clutch discs 9a forming the first clutch disc group 9 are fitted.

The second partition member 8 is spline-engaged with the input shaft 6 so as to be rotated together with the input shaft 6 and forms a hydraulic chamber S2 cooperating with the hydraulic piston Pa. In particular, the second partition member 8 is formed with a through aperture on which a spline 8b is formed so as to be engaged with the spline formed on the input shaft 6, as shown in FIG. 3. A reference numeral 8a denotes a hydraulic oil supplying aperture via which the operating oil can be supplied to the hydraulic chamber S2. In addition, a reference numeral 8c denotes a spline on which driven clutch discs 10a forming the second clutch disc group 10 are fitted.

Thus, the first and second partition members 7, 8 are spline-engaged with the input shaft 6 and arranged oppositely to each other to form the hydraulic chambers S1, S2, sandwiching the hydraulic piston Pa between the first and second partition members 7, 8. Reference numerals f1, f2 denote sealing members mounted on the first and second partition members 7, 8, respectively.

The first clutch disc group 9 comprises alternately interleaved driving clutch discs 9a spline-engaged with the spline 7c of the first partition member 7 and driven clutch discs 9b spline-engaged with the output side (e.g., an output member 14 connected to the gear G1). When the driving clutch discs 9a and driven clutch discs 9b are engaged by actuation of the hydraulic piston Pa, driving power of the input shaft 6 can be transmitted to the gear G1. On the contrary, when the driving clutch discs 9a and driven clutch discs 9b are disengaged by releasing actuation of the hydraulic piston Pa, driving power of the input shaft 6 cannot be transmitted to the gear G1. The term “disengage” used herein means a condition where pressure applied to the clutch discs is released and thus is not limited to a physically separated condition.

The second clutch disc group 10 comprises alternately interleaved driving clutch discs 10a spline-engaged with the spline 8c of the second partition member 8 and driven clutch discs 10b spline-engaged with the output side (e.g., an output member 15 connected to the gear G2). When the driving clutch discs 10a and driven clutch discs 10b are engaged by actuation of the hydraulic piston Pa, driving power of the input shaft 6 can be transmitted to the gear G2. On the contrary, when the driving clutch discs 10a and driven clutch discs 10b are disengaged by releasing actuation of the hydraulic piston Pa, driving power of the input shaft 6 cannot be transmitted to the gear G2.

The hydraulic piston Pa can be operated by hydraulic oil supplied to either one of the hydraulic chamber S1, S2 and can selectively engage or disengage the driving clutch discs 9a, 10a and the driven clutch discs 9b, 10b of the first or second clutch disc groups 9 or 10 in accordance with the displaced direction of the hydraulic piston Pa. As shown in FIG. 3, the hydraulic piston Pa of the present disclosure comprises a hydraulic pressure receiving portion “a” positioned within the hydraulic chambers S1, S2 for receiving the hydraulic pressure, an actuating portion “b” integrally formed with the hydraulic pressure receiving portion “a” for engaging and disengaging the driving clutch discs 9a, 10a and the driven clutch discs 9b, 10b of the first clutch disc group 9 and the second clutch disc group 10, a sliding portion “c” provided with seals f1, f2 and slidable relative to the first and second partition members 7, 8, and seals 11 for sealing the hydraulic chambers S1, S2. The seals f1, f2, 11 can serve as means for sealing the hydraulic chambers S1, S2.

The hydraulic chambers S1, S2 are sealed from each other by the seals 11 mounted on the hydraulic piston Pa and the seals f1, f2 mounted respectively on the first partition member 7 and the second partition member 8. Although it is shown in the illustrated embodiment that the seals 11 and the seals f1, f2 are those having lips, it may be possible to use other types of seals such as O-rings or gaskets.

When a hydraulic pressure is applied to the hydraulic chamber S2 by supplying hydraulic oil thereto, the hydraulic piston Pa is moved toward the left and the actuating portion “b” of the hydraulic piston Pa presses the first clutch disc group 9 and engages the driving clutch discs 9a and driven clutch discs 9b. Accordingly, the driving power of the engine E can be transmitted to the output member 14 and thus driving power corresponding to the gear ratio determined by the gear G1 can be transmitted. On the contrary, when a hydraulic pressure is applied to the hydraulic chamber Si by supplying hydraulic oil thereto, the hydraulic piston Pa is moved toward the right and the actuating portion “b” of the hydraulic piston Pa presses the second clutch disc group 10 and engages the driving clutch discs 10a and driven clutch discs 10b. Accordingly, the driving power of the engine E can be transmitted to the output member 15 and thus driving power corresponding to the gear ratio determined by the gear G2 can be transmitted.

It may be possible to arrange any urging means (e.g., return springs, etc.) for returning the hydraulic piston Pa to its initial position (e.g., neutral position) when the pressure applied to the hydraulic piston Pa is released by stopping supply of hydraulic oil to the hydraulic chambers S1, S2. When the hydraulic piston Pa is returned to the initial position, the driving clutch discs 9a, 10a and the driven clutch discs 9b, 10b are disengaged and the power transmission can be cut off.

As described above, the driving power of the engine E can be transmitted to the driving wheels D at a desired gear ratio by selectively moving the hydraulic piston Pa in the right or left direction by selectively supplying hydraulic oil to the hydraulic chambers S1 or S2. Since the hydraulic piston Pa can be commonly used for changing the gear ratio, it is possible to reduce the size (e.g., especially the axial size), the number of parts, and thus the cost of the power transmitting apparatus.

The input shaft 6 of the present disclosure is formed with oil passages 6a, 6b axially extending in the input shaft 6 toward a hydraulic pressure source (not shown), and hydraulic oil supplying ports P1, P2 radially branched respectively from the oil passages 6a, 6b toward the hydraulic chambers S1, S2 (e.g., particularly, hydraulic oil supplying apertures 7a, 8a). That is, the hydraulic oil supplying port P1 is in communication with the hydraulic chamber S1 via the hydraulic oil supplying aperture 7a formed in the first partition member 7 and the hydraulic oil supplying port P2 is in communication with the hydraulic chamber S2 via the hydraulic oil supplying aperture 8a formed in the second partition member 8.

Thus, the hydraulic piston Pa can be moved toward the right direction in FIG. 2 by supplying hydraulic oil to the hydraulic chamber S1 via the oil passage 6a and the hydraulic oil supplying port P1 and applying hydraulic pressure onto the left-side surface of the hydraulic pressure receiving portion “a.” The hydraulic piston Pa can be moved toward the left direction in FIG. 2 by supplying hydraulic oil to the hydraulic chamber S2 via the oil passage 6b and the hydraulic oil supplying port P2 and applying hydraulic pressure onto the right-side surface of the hydraulic pressure receiving portion “a.”

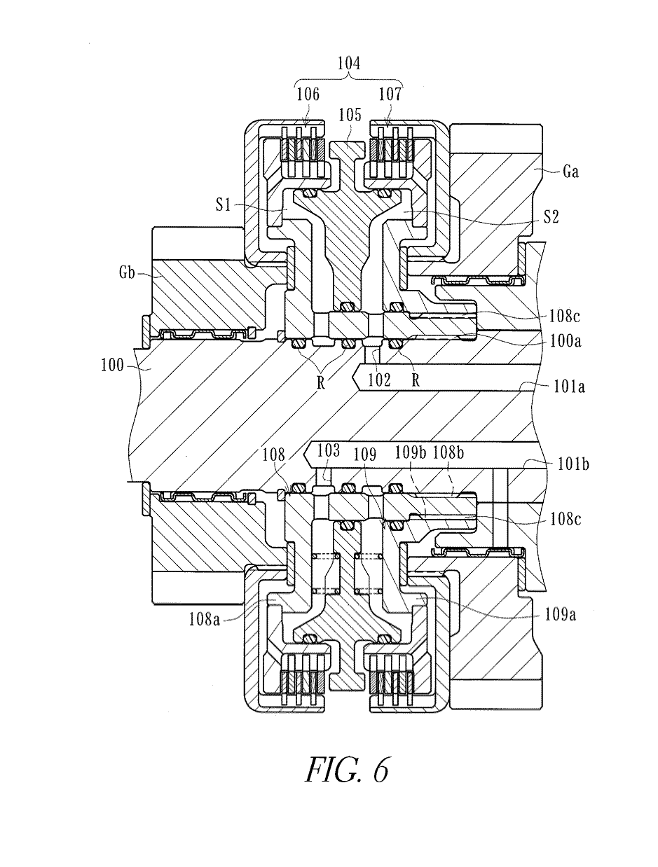

In addition, according to the present disclosure, the input shaft 6 is formed with a splined portion α able to be engaged with partition member 7 or 8 and a non-splined portion β in which the hydraulic oil supplying ports P1, P2 are formed. The splined portion α and the non-splined portion β are formed on the same plane of a radial cross-section of the input shaft 6, as shown in FIG. 5. That is, the input shaft 6 is formed with the splined portion α and the non-splined portion β (e.g., the portion in which the opening of the hydraulic oil supplying port P1, P2 is formed) on the same plane of a radial cross-section of the input shaft 6.

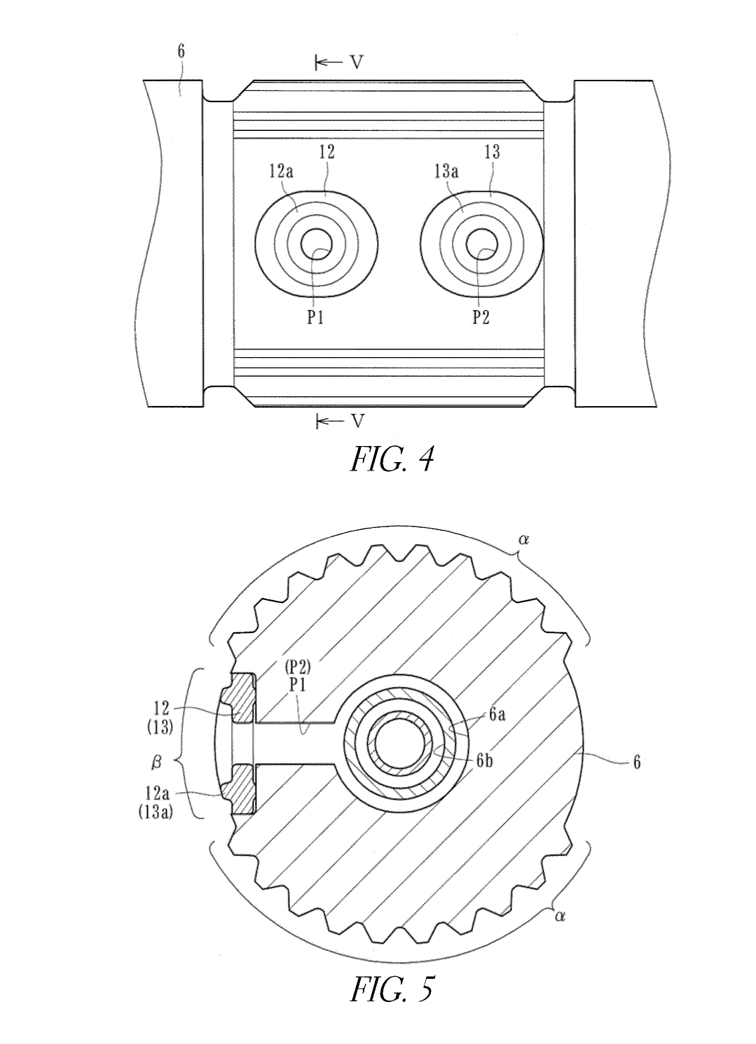

Further, according to the present disclosure, annular sealing members 12, 13 are mounted on the outer circumference of the input shaft 6 so that they encircle the openings of the hydraulic oil supplying ports P1, P2. As shown in FIG. 4, sealing members 12, 13 have oval outline configurations and are formed with circular contacting portions 12a, 13a contacted with the inner circumference of the first and second partition members 7, 8 around the periphery of the hydraulic oil supporting apertures 7a, 8a. The sealing members 12, 13 can be formed of by molding materials having sealing characteristics, such as soft metal, resin or rubber, etc.

As described above, since the annular sealing members 12, 13 are mounted on the input shaft 6 so that they encircle the openings of the hydraulic oil supplying port P1, P2, it is possible that they can independently seal the hydraulic oil supplying ports P1, P2. In addition, since the sealing members 12, 13 have the oval outline configuration, it is possible to prevent unintentional rotation of the sealing member 12, 13 relative to the recessed portion 6c of the input shaft 6. Other outline configurations of the sealing member 12, 13 and the recessed portion 6c, such as a rectangular configuration, may be possible if they can prevent rotation of the sealing member relative to the recessed portion.

On the other hand, the gear-stage selector 5 comprises, for example, a microcomputer mounted on a vehicle and can control the hydraulic pressure supplied to the gear-stage clutch 3 and arbitrarily set the gear ratio in power transmission from the engine E to the driving wheels D by selectively engaging either one of the first clutch disc group 9 or the second clutch disc group 10. The gear-stage selector 5 can serve as a means of controlling the hydraulic pressure supplied to the gear-stage clutch 3. Accordingly, the controller 4 and the gear-stage selector 5 can selectively actuate the start/speed shifting clutch 2 and the gear-stage clutch 3 in accordance with pre-set modes.

According to the present disclosure, since the first partition member 7 and the second partition member 8 are spline-engaged with the input shaft 6 so as to be rotated together with the input shaft 6 and arranged oppositely to each other to form the hydraulic chambers S1, S2, it is possible to reduce the size of the power transmitting apparatus and to improve its power transmitting efficiency. That is, since both the first partition member 7 and the second partition member 8 forming the hydraulic chambers S1, S2 are directly spline-engaged with the input shaft 6, it is possible to reduce the size both in the radial direction (e.g., the width) and in the axial direction (e.g., the height) and thus the whole size of the power transmitting apparatus can be reduced and efficient power transmission can be achieved.

In addition, since the hydraulic piston Pa comprises a hydraulic pressure receiving portion “a” positioned within the hydraulic chambers S1, S2 for receiving the hydraulic pressure, an actuating portion “b” integrally formed with the hydraulic pressure receiving portion “a” for engaging and disengaging the driving clutch discs 9a, 10a and the driven clutch discs 9b, 10b of the first clutch disc group 9 and the second clutch disc group 10, and seals 11 for sealing the hydraulic chambers S1, S2, it is possible to surely transmit the hydraulic pressure received by the hydraulic pressure receiving portion “a” to the actuating portion “b” and to more surely engage or disengage the driving clutch discs 9a, 10a and driven clutch discs 9b, 10b of either one of the first clutch disc group 9 or the second clutch disc group 10.

Furthermore, since the input shaft 6 is formed with hydraulic oil supplying ports P1, P2 for supplying the hydraulic chambers S1, S2 with hydraulic oil, and further formed with a splined portion α able to be engaged with the first and second partition members 7, 8 and a non-splined portion β in which the openings of the hydraulic oil supplying ports P1, P2 are formed, and the splined portion α and the non-splined portion β are formed on the same plane of a radial cross-section of the input shaft 6, it is possible to further reduce the axial size (e.g., the height), and thus the whole size of the power transmitting apparatus.

Although it has been described a preferable embodiment of the present disclosure, the present disclosure is not limited to the described and illustrated embodiment. For example, the plurality of hydraulic oil supplying ports P1, P2 may be formed on the same plane of a radial cross-section of the input shaft 6 and the annular sealing members 12, 13 may be mounted on the the input shaft 6 around the oil supplying ports P1, P2, respectively. The power transmitting apparatus of the present disclosure may be applied to other vehicles than automobiles.

The present disclosure can be applied to any power transmitting apparatus in which the power transmitting apparatus comprises a first partition member and a second partition member spline-engaged with the input shaft so as to be rotated together therewith and arranged oppositely to each other to form hydraulic chambers; a first clutch disc group comprising driving clutch discs spline-engaged with the first partition member and driven clutch discs spline-engaged with the output member, the driving clutch discs and the driven clutch discs being alternately interleaved with each other; a second clutch disc group comprising driving clutch discs spline-engaged with the second partition member and driven clutch discs spline-engaged with the output member, the driving clutch discs and the driven clutch discs being alternately interleaved with each other; and a hydraulic piston actuated by hydraulic pressure supplied to the hydraulic chambers to selectively engage or disengage the driving clutch discs and driven clutch discs of either one of the first clutch disc group or the second clutch disc group in accordance with the actuated direction of the hydraulic piston, the driving power able to be transmitted at a desirable gear ratio by selectively actuating the hydraulic piston, although it is one having a different external view or one to which any other function is added.

What is claimed is:

1. A power transmitting apparatus arranged on a power transmitting path between an engine and driving wheels and adapted to connect an input from an input shaft of an engine side of the power transmitting apparatus and an output to a driving wheel side of the power transmitting apparatus at a predetermined gear ratio and arranged to arbitrarily set the gear ratio during power transmission from the engine to the driving wheels, the power transmitting apparatus comprising:
a first partition member and a second partition member spline-engaged with the input shaft, the first partition member and second partition member configured to be rotated together with the input shaft and arranged oppositely to each other to form hydraulic chambers;
a first clutch disc group comprising driving clutch discs spline-engaged with the first partition member and driven clutch discs spline-engaged with the output member, the driving clutch discs and the driven clutch discs of the first clutch disc group being alternately interleaved with each other;
a second clutch disc group comprising driving clutch discs spline-engaged with the second partition member and driven clutch discs spline-engaged with the output member, the driving clutch discs and the driven clutch discs of the second clutch disc group being alternately interleaved with each other; and
a hydraulic piston configured to be actuated by hydraulic pressure supplied to the hydraulic chambers to selectively engage or disengage the driving clutch discs and driven clutch discs of either one of the first clutch disc group or the second clutch disc group in accordance with an actuated direction of the hydraulic piston, a driving power configured to be transmitted at a desirable gear ratio by selectively actuating the hydraulic piston.

2. The power transmitting apparatus of claim 1 wherein the hydraulic piston comprises a hydraulic pressure receiving portion positioned within the hydraulic chambers for receiving the hydraulic pressure, an actuating portion integrally formed with the hydraulic pressure receiving portion for engaging and disengaging the driving clutch discs and the driven clutch discs of the first clutch disc group and the second clutch disc group, and sealing means for sealing the hydraulic chambers.

3. The power transmitting apparatus of claim 1 wherein the input shaft is formed with hydraulic oil supplying ports for supplying the hydraulic chambers with hydraulic oil, the input shaft further formed with a splined portion able to be engaged with the first and second partition members and a non-splined portion in which openings of the hydraulic oil supplying ports are formed, and wherein the splined portion and the non-splined portion are formed on a same plane of a radial cross-section of the input shaft.

4. The power transmitting apparatus of claim 2 wherein the input shaft is formed with hydraulic oil supplying ports for supplying the hydraulic chambers with hydraulic oil, the input shaft further formed with a splined portion able to be engaged with the first and second partition members and a non-splined portion in which openings of the hydraulic oil supplying ports are formed, and wherein the splined portion and the non-splined portion are formed on a same plane of a radial cross-section of the input shaft.

5. The power transmitting apparatus of claim 3 wherein annular sealing members are mounted on an outer circumference of the input shaft so that they encircle the openings of the hydraulic oil supplying ports.

6. The power transmitting apparatus of claim 4 wherein annular sealing members are mounted on an outer circumference of the input shaft so that they encircle the openings of the hydraulic oil supplying ports.

7. The power transmitting apparatus of claim 1 wherein the hydraulic piston comprises a hydraulic pressure receiving portion positioned within the hydraulic chambers for receiving the hydraulic pressure, an actuating portion integrally formed with the hydraulic pressure receiving portion for engaging and disengaging the driving clutch discs and the driven clutch discs of the first clutch disc group and the second clutch disc group, and at least one seal for sealing the hydraulic chambers.

8. The power transmitting apparatus of claim 7 wherein the input shaft is formed with hydraulic oil supplying ports for supplying the hydraulic chambers with hydraulic oil, the input shaft further formed with a splined portion able to be engaged with the first and second partition members and a non-splined portion in which openings of the hydraulic oil supplying ports are formed, and wherein the splined portion and the non-splined portion are formed on a same plane of a radial cross-section of the input shaft.

9. The power transmitting apparatus of claim 8 wherein annular sealing members are mounted on an outer circumference of the input shaft so that they encircle the openings of the hydraulic oil supplying ports.
